(19) United States
(12) Patent Application Publication
(10) Pub. No.: US 2021/0140640 A1
(43) Pub. Date: May 13, 2021

(54) Injector for Dispensing an Effervescent Fluid and a Fluid Injector System Thereof

(71) Applicant: Indian Institute of Science, Bangalore (IN)

(72) Inventors: Saptarshi Basu, Bangalore (IN); Kuppuraj Rajamanickam, Bangalore (IN); Swapneel Roy, Bangalore (IN); Swetaprovo Chaudhuri, Bangalore (IN)

(21) Appl. No.: 16/621,453

(22) PCT Filed: Jun. 12, 2018
(86) PCT No.: PCT/IB2018/054229

§ 371 Date: Dec. 11, 2019

(30) Foreign Application Priority Data
Jun. 13, 2017 (IN) 201741020629

(51) Int. Cl. F23R 3/28

(52) U.S. Cl. CPC F23R 3/286; B05B 7/066; F23R 3/283

(57) ABSTRACT

Present disclosure relates to a injector, which comprises a first lance, provisioned with at least one first inlet port, to receive a first fluid. Further, a second lance is coaxially disposed within the first lance, and provisioned with at least one second inlet port, to receive a second fluid. The injector further includes a tube member, disposable within the second lance to receive the first fluid at one end, while sealed at another end. The tube member is provisioned with at least one recess for the first fluid in the tube member to mix with the second fluid and form the effervescent fluid. The effervescent fluid is then dispensed through at least one of a first exit port of the first lance and a second exit port of the second lance. The injector may be employed in applications such as, fuel injection, spray coating and the like.

### TECHNICAL FIELD

Present disclosure generally relates to the field of fluid mechanics. Particularly, but not exclusively, the disclosure relates to fluid dispensing devices. Further, embodiments of the present disclosure relate to an injector assembly, for use in applications such as, but not limited to, fuel injection engines.

### BACKGROUND OF THE DISCLOSURE

In fluid mechanics, injectors and atomizers are used for changing state of flow of fluid. Both injectors and atomizers may be used as individual components for performing discrete functions such as, atomizers being used to atomize a fluid, while the injectors being used for injecting the fluid, or the fluid that has been atomized. However, these injectors and atomizers may also be custom fitted or retrofitted to form an integral component, where the injector and atomizer may be programmed to synchronously function, as twin-fluid atomizing nozzles. Such injectors and atomizers may be equipped based on applications including, but not limited to, fuel injection units, food processing units, spray coating units, and the like.

One such application where the twin-fluid atomizing nozzles, or in other words, the injector may be integrated with the atomizer, may be in the fuel injection units of a scramjet engine. The scramjet engines are used in the aerospace industry for propulsion of heavy payload carriers including, but not limiting to, a cargo aircraft, a jet and the like. The scramjet engines, in general, operate on varying fluid pressures, for combustion of fuel mixture to generate optimal thrust. The twin fluid atomizing nozzles or injectors may be employed in the fuel injection units of such scram jet engines, to assist in supplying adequate quantity of fuel mixture by breaking down the fuel mixture into smaller particulates. The smaller particulates may then be subjected for combustion, to generate the thrust, for propulsion.

However, conventionally available twin fluid atomizing nozzles fail to match the operating conditions of the scramjet engines due to various reasons. Some of the problems associated with the conventional twin fluid atomizing nozzles include fuel pressure drop, lower fuel particulate size, liquid flow rate, high flow velocity required for efficient mixing, penetration ability of the fuel particulates and the like. Further, the twin fluid atomizing nozzles may be manufactured specific to their application in relevant fields or industries. Also, the particulate size achieved and injected by the twin fluid atomizing nozzles may not be conducive for scramjet operation, as flow rates, flow capacities and medium particulate size of the particulates are lower than the requirement. Due to the poor performance characteristics of the medium particulate size, that are dispensed by the conventional twin fluid atomizing nozzles, incomplete combustion of the fuel may arise in the scramjet engine, thereby, thrust generated is well short of the required thrust, for propulsion. Thus, resulting in reduction in efficiency of the scramjet engine.

The present disclosure is directed to overcome one or more limitations stated above.

The information disclosed in this background of the disclosure section is only for enhancement of understanding of the general background of the invention and should not be taken as an acknowledgment or any form of suggestion that this information forms the prior art already known to a person skilled in the art.

### SUMMARY OF THE DISCLOSURE

One or more shortcoming of the prior arts and conventional systems are overcome by providing an injector for use in applications such as, but not limited to, scramjet engines, food processing, spray coating, painting, and the like.

In a non-limiting embodiment of the present disclosure an injector for dispensing an effervescent fluid is disclosed. The injector comprises a first lance, which is provisioned with at least one first inlet port, to receive a first fluid. Further, a second lance is coaxially disposed within the first lance, and is provisioned with at least one second inlet port, to receive a second fluid. The injector further includes a tube member, which is disposable within the second lance to receive the first fluid at one end and sealed at another end. The tube member is provisioned with at least one recess for the first fluid in the tube member to mix with the second fluid of the second lance and form the effervescent fluid. The effervescent fluid is then dispensed through at least one of a first exit port of the first lance and a second exit port of the second lance.

In an embodiment, the at least one first inlet port is positioned about a transverse plane of the first lance, and is configured to perpendicularly extend along the transverse plane.

In an embodiment, the at least one second inlet port is configured to perpendicularly extend from the second lance, about an axial axis of the second lance.

In an embodiment, the at least one first inlet port of the first lance and the tube member are connectable with a first fluid supplying apparatus, to receive the first fluid.

In an embodiment, the first fluid conveyed through the first lance is configured to propel the effervescent fluid, via the first exit port.

In an embodiment, the at least one first inlet port includes a first port and a second port, positioned on an axial axis.

In an embodiment, the first port is positioned along the axial axis and the second port is positioned on an axial axis.

In an embodiment, the tube member is coupled to the second lance at a first end, which is projected outwardly from the second lance, and the second end is adapted to be positioned proximal to the second exit port.

In another non-limiting embodiment of the present disclosure, a fluid injector system is disclosed. The system comprises a first fluid supplying apparatus configured to supply a first fluid, and a second fluid supplying apparatus configured to supply a second fluid. Further, the system includes an injector. The injector consists of a first lance, which is provisioned with at least one first inlet port, to receive the first fluid. Further, a second lance is coaxially disposed within the first lance, and is provisioned with at least one second inlet port, to receive the second fluid. The injector further includes a tube member, which is disposable within the second lance to receive the first fluid at one end and sealed at another end. The tube member is provisioned with at least one recess for the first fluid in the tube member to mix with the second fluid of the second lance and form the effervescent fluid. The effervescent fluid is then dispensed through at least one of a first exit port of the first lance and a second exit port of the second lance.

In an embodiment, the at least one first inlet port is positioned about a transverse plane of the first lance and is configured to perpendicularly extend along the transverse plane, to connect with the first fluid supplying apparatus.

In an embodiment, the at least one second inlet port is configured to perpendicularly extend from the second lance, about an axial axis of the second lance, to connect with the second fluid supplying apparatus.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the detailed disclosure. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 is a sectional view of an injector for dispensing an effervescent fluid, in accordance with an embodiment of the present disclosure.

FIGS. 2a and 2b are top views of the injector, illustrating variations in the configuration of a first inlet port of a first lance therein, in accordance with an embodiment of the present disclosure.

FIG. 3a is a pictorial representation of the injector with the effervescent fluid being dispensed therethrough, in accordance with an embodiment of the present disclosure.

FIG. 3b is a magnified view of the pictorial representation of FIG. 3a, to indicate particulate size in the effervescent fluid which is dispensed by the injector.

FIG. 3c depicts a graphical representation, illustrating a variation of particulate size with reference to pressure of a first fluid in the first lance, in accordance with an embodiment of the present disclosure.

FIGS. 4a is a pictorial representation of the injector with the effervescent fluid being propelled therethrough, in accordance with an embodiment of the present disclosure.

FIG. 4b is a magnified view of the pictorial representation of FIG. 4a, to indicate particulate size in the effervescent fluid which is propelled by the injector.

FIG. 4c depicts a graphical representation, illustrating a variation of particulate size with reference to pressure of the first fluid in the first lance, in accordance with an embodiment of the present disclosure.

FIG. 5 is a schematic view of a scramjet engine equipped with the injector, in accordance with an exemplary embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

While the embodiments of the disclosure are subject to various modifications and alternative forms, specific embodiment thereof has been shown by way of example in the figures and will be described below. It should be understood, however that it is not intended to limit the disclosure to the particular forms disclosed, but on the contrary, the disclosure is to cover all modifications, equivalents, and alternative falling within the scope of the disclosure.

It is to be noted that a person skilled in the art would be motivated from the present disclosure and modify various shapes, profiles, orientation and configurations of an injector and a fluid injector system. However, such modification should be construed within the scope and spirit of the instant disclosure. Accordingly, the drawings show only those specific details that are pertinent to understand the embodiments of the present disclosure so as not to obscure the disclosure with details that will be readily apparent to those of ordinary skilled in the art having benefit of the description herein.

The terms “comprises”, “comprising”, or any other variations thereof used in the disclosure, are intended to cover a non-exclusive inclusion, such that a device, a mechanism, a system, and a method, that comprises a list of components does not include only those components but may include other components not expressly listed or inherent to such system, or assembly, or device, or mechanism. In other words, one or more elements in a system or an assembly proceeded by “comprises . . . a” does not, without more constraints, preclude the existence of other elements or additional elements in the device or the system or the mechanism.

Embodiments of the disclosure discloses an injector for dispensing an effervescent fluid. The injector comprises a first lance, which is provisioned with at least one first inlet port, to receive a first fluid. Further, a second lance is coaxially disposed within the first lance, and is provisioned with at least one second inlet port, to receive a second fluid. The injector further includes a tube member, which is disposable within the second lance to receive the first fluid at one end and sealed at another end. The tube member is provisioned with at least one recess for the first fluid in the tube member to mix with the second fluid of the second lance and form the effervescent fluid. The effervescent fluid is then dispensed through at least one of a first exit port of the first lance and a second exit port of the second lance.

In another non-limiting embodiment of the present disclosure, a fluid injector system is disclosed. The system comprises a first fluid supplying apparatus configured to supply the first fluid, and a second fluid supplying apparatus configured to supply the second fluid. Further, the system includes the injector. The injector consists of the first lance, which is provisioned with at least one first inlet port, to receive the first fluid. Further, the second lance is coaxially disposed within the first lance, and is provisioned with an at least one second inlet port, to receive the second fluid. The injector further includes a tube member, which is disposable within the second lance to receive the first fluid at one end and sealed at another end. The tube member is provisioned with at least one recess for the first fluid in the tube member to mix with the second fluid of the second lance and form the effervescent fluid. The effervescent fluid is then dispensed through at least one of a first exit port of the first lance and a second exit port of the second lance.

In the following detailed description of the embodiments of the disclosure, reference is made to the accompanying figures that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

FIG. 1 is an exemplary embodiment of the disclosure depicting a sectional view of an injector (50). The injector (50) includes a first lance (1), which is constructed in a way to resemble a nozzle. The first lance (1) may consist of an elongated body, that may include at least one first inlet port (3a), and a converging portion at one side of the elongated body, to form a first exit port (7a). In an embodiment, the at least one first inlet port (3a) may be configured to receive a first fluid. Further, the injector (100) includes a second lance (2), where the second lance (2) is coaxially disposed within the first lance (1). Also, the second lance (2) may be profiled in conjunction with the first lance (1), and may include a second exit port (7b) being disposed proximal to the first exit port (7a). The second lance (2) may further be configured to outwardly extend from the first lance (1), in a direction opposite to the first exit port (7a) and the second exit port (7b). In an embodiment, at least one second inlet port (3b) may be provided in the extended portion of the second lance (2), to receive a second fluid. Additionally, it may be noted that the second lance (2) may be disposed within the first lance (1) such that, the first fluid flowing through the first lance (1) may circumscribe a portion of the second lance (2) which may be positioned therein.

The second lance (2) is adapted to house a tube member (4). The tube member (4) may be configured to receive the first fluid at a first end (5a), while a second end (5b) of the tube member (4) may be sealed. Here, it may be noted that the first end (5a) of the tube member (4) may be positioned outside the second lance (2) to receive the first fluid, whereas the second end (5b) of the tube member (4) may be introduced within the second lance (2). The tube member (4) is coupled to the second lance (2) at a region proximal to the first end (5a) by a securing means (8). In an embodiment, the securing means (8) may be at least one of a cork plug, a rubber plug, a clamp and the like. Due to the configuration of the securing means (8), the tube member (4) may be suspended within the second lance (2), which in-turn results in circumscription of the tube member (4) by the second fluid flowing through the second lance (2).

Further, the tube member (4) may include at least one recess (6), between the first end (5a) and the second end (5b) of the tube member (4). The at least one recess (6) may be adapted to fluidly communicate the first fluid in the tube member (4) to mix with the second fluid flowing through the second lance (2). This mixing of the first fluid, from the at least one recess (6), with the second fluid, in the second lance (2), results in formation of an effervescent fluid. The effervescent fluid may then be dispensed via at least one of the first exit port (7a) of the first lance (1) and the second exit port (7b) of the second lance (2).

In an embodiment, the at least one first inlet port (3a) is located on the first lance (1), with an axial axis of each of the at least one first inlet port (3a) overlying on a transverse plane (A-A) of the first lance (1), as best seen in FIGS. 2a and 2b. Further, the at least one first inlet port (3a) may be adapted to outwardly extend from a periphery of the first lance (1), along corresponding axial axis therefrom. It may be noted that the location of the transverse plane (A-A) on the first lance (1) may not be a limiting parameter, but, may be located at a portion of the first lance (1) which may be perpendicular to an axial axis (B-B) of the first lance (1).

In an embodiment, the at least one second inlet port (3b) may be provisioned in the second lance (2) such that, the at least one second inlet port (3b) may outwardly and perpendicularly extends about the axial axis (B-B) of the second lance (2). Here, one skilled in the art should not construed that the orientation and/or outward extension of the at least one first lance (1) and the at least one second lance (2) to be a limitation of the injector (100). It may be noted that the orientation and/or outward extension may be modified in accordance with various constructional parameters of the injector (50). In an embodiment, the constructional parameters of the injector (50) may be including, but not limited to, number of the inlet ports, required angular induction of the first fluid and the second fluid, volume of the first fluid and the second fluid to be inducted, viscosity of the first fluid and the second fluid, and the like. Also, in an embodiment, the second lance (2) may be longitudinally covered by the first lance (1), due to which, the at least one second inlet port (3b) may extend from the periphery of the second lance and through the first lance, to receive the second fluid.

In an embodiment, the injector (100) during operation may allow the first fluid to flow through the first lance (1) and the tube member (4), while the second fluid may be allowed to flow through the second lance (2). Since the second end (5b) of the tube member (4) is sealed, the first fluid may be allowed to fluidly communicate into the second lance (2). This communication of the first fluid with the second lance (2) may result in mixing therebetween, in the second lance (2). The mixing of the first fluid and the second fluid renders formation of the effervescent fluid, which then results in atomization of the effervescent fluid when dispensed from the injector (100). In addition, the first fluid passing through the first lance (1) assists in propelling the atomized effervescent fluid from the injector (100), to dispense and disperse the effervescent fluid to a wider area. Furthermore, the effervescent fluid may be dispersed from the injector (100) through at least one of the first exit port (7a) of the first lance (1) and the second exit port (7b) of the second lance (2).

In an exemplary embodiment, the first lance (1) includes a first port (3a′) and a second port (3a″) as shown in FIGS. 2aand 2b. Referring to FIG. 2a, the axial axis (C-C) of the first port (3a′) and the axial axis (C′-C′) of the second port (3a″) are collinear with one another, and lay on the transverse plane (A-A) of the first lance (1). Such a configuration of the first port (3a′) and the second port (3a″) allows the first fluid flowing through the first lance (1) to linearly propel the effervescent fluid, and the effervescent fluid being dispensed and dispersed from the injector (100).

Furthermore, in an exemplary embodiment, the first port (3a′) and the second port (3a″) may also be eccentrically positioned about the axial axis (B-B) [as referred from FIG. 1] of the first lance (1), as best seen in FIG. 2b. For example, the first port (3a′) may be configured to extend along the axial axis (C-C), while the second port (3a″) may be configured to extend along the axial axis (C′-C′). Also in this configuration of the at least one first inlet port (3a), the first port (3a′) and the second port (3a″) may be configured to lay on the transverse plane (A-A). However, in an embodiment, the first port (3a′) and the second port (3a″) may be located on different planes, which may be parallel to the transverse plane (A-A) of the first lance (1). In this configuration, the at least one first inlet port (3a) and the first fluid flowing through the first lance (1) may obliquely propel the effervescent fluid. Such oblique propulsion of the effervescent fluid imparts a swirl action, during dispersing of the effervescent fluid. In an embodiment, the swirl action of the effervescent fluid may generate a dispersion area in the range of about 40° to about 60° therearound.

In an embodiment, due to linear propulsion and/or oblique propulsion, the effervescent fluid, which may be dispensed and dispersed from the injector (100), may be atomized into particulates thereby, resulting in higher penetration length of discharge from the injector (100). It may be noted that, in the linear/oblique propulsion of the effervescent fluid, the particulates may include characteristics such as, but not limited to, fine particle size, higher kinetic energy, and the like.

Referring now to FIGS. 3a and 3b, which are exemplary embodiments of the present disclosure illustrating pictorial representations. The effervescent fluid is being dispensed from the injector (100), and particulates of the effervescent fluid [herein also referred to as “particulates”] are also depicted. The particulates are formed due to atomizing, dispensing and dispersing of the effervescent fluid. The effervescent fluid may be suitably dispersed from the injector (100) based on requisite application. It may be noted that the size of the particulates dispensed from the injector (100) may be controlled and regulated based on the factors including, but not limited to, pressure of the second fluid within the second lance (2), number of recesses in the tube member (4), diameter of the first exit port (7a) and the second exit port (7b), fluid properties of the first fluid and the second, and the like.

Further, an exemplary experiment has been conducted for analyzing performance of the injector (100), with water as the second fluid, while air is used as the first fluid. In the exemplary experimental set-up, the tube member (4) is provisioned with twelve recesses. Upon operating the injector (100) for atomizing the effervescent water, an air pressure in the tube member (4) is maintained in the range of about 2 bar to about 2.6 bar. Also, the first lance (1) was maintained unoperated, as no pressurized air was supplied therethrough. It was noted that particulates [i.e. water droplets] were dispensed due to the effervescent water from the injector (100). This effervescent water resulted in formation of the particulates of the water droplets with a mean diameter in the range of about 47 μm to about 48 μm. FIG. 3c is a bar-graph depicting diameter of the particulates as a function of normalized droplet count, to indicate the size range of the particulates. It may be observed that, due to atomization of the effervescent water, about 60% to about 65% of the normalized droplet count have the particulates with the mean diameter in range of about 10 μm or even less. Thus, a major aggregate of particulates has the mean diameter beyond the range of about 10 μm thereby, producing medium sized droplets.

Referring now to FIGS. 4a and 4b, which are pictorial representations of the effervescent fluid, dispensed from the injector (100), with the first lance (1) being in operation condition. In this exemplary experiment, the at least one first inlet port (3a) of the first lance (1) is supplied with the first fluid, at a pressurized state. Due to this pressurized state of the first fluid, the effervescent fluid being dispensed from the injector (100) may be subjected to a thrust, which results in propulsion and fine dispersion of the effervescent fluid. The particulates so formed due to dispensing of the effervescent fluid may also be disintegrated into finer particulates. The finer particulates may possess particles in reduced size, in comparison with the particulates formed when the first lance (1) is in the unoperated condition. Also, the finer particulates may possess higher kinetic energy, due to the pressurized state of the first fluid in the first lance (1). It may be noted that the size of the finer particulates may be controlled and regulated based on the factors including, but not limited to, pressure of the second fluid within the second lance (2), pressure of the first fluid in the first lance (1), orientation of the at least one first inlet port (3a), fluid properties of the first fluid and the second fluid, and the like.

Further, an experiment has been conducted for analyzing performance of the injector (100), with water as the second fluid in the second lance (2), while air is used as the first fluid in each of the first lance (1) and the tube member (4). During the exemplary experiment, upon supplying air in the first lance (1), air is pressurized to be discharged from the first lance (1) at a flow rate of about 200 liters/minute to about 400 liters/minute. Fine particulates are configured to be dispensed therethrough. The fine particulates formed may have a mean diameter in the range of about 15 μm to about 18 μm. FIG. 4c is a bar-graph with diameter of the finer particulates formed due to pressurized state of the first fluid in the first lance (1), as a function of normalized droplet count, to indicate the size range of the finer particulates in the bar graph. It may be observed that due to propulsion and dispersing of the effervescent water, about 68% to about 72% of the normalized droplet count have the fine particulates with the mean diameter in range of about 10 μm or even less. Thus, a major aggregate of the particulates have the mean diameter less than the range of about 10 μm thereby, producing small sized droplets.

Turning to FIG. 5, which illustrates schematic diagram of a scram jet engine (100), employed with the injector (50). The injector (50) may be utilized for injecting fuel mixture, for combustion and propulsion processes to drive a scram jet [not shown in Figures]. The injector (50) may be positioned between an air-inlet chamber (20) and a combustion chamber (21), with a first fluid supplying apparatus (150) configured to supply the first fluid, and a second fluid supplying apparatus (200) configured to supply the second fluid to the injector (100). It may be noted that, the first fluid and the second fluid may be two-discrete fluids, which forms a combustible fuel mixture when injected through the injector (50). The fuel mixture may be atomized by the injector (50) to produce particulates of fine size, in order to ensure complete combustion within the scram jet engine (100). As shown in the exemplary embodiment, the injector (50) may be arranged in cross-flow configuration, to inject fuel mixture, for deriving propulsion movement of the scramjet engine (100), however, the injector (50) may also be arranged in any other oblique configuration, as desired. It may be noted that, the fuel mixture injected from the injector (50), also undergo higher penetration length, due to which effortless combustion of the particulates may occur, rendering in producing optimal thrust for propulsion. In an embodiment, the first fluid and the second fluid supplied to the injector (50) may be the combustible fluid or an oxidizing fluid such as, but not limited to, petroleum, diesel, kerosene, ethylene, and the like.

In an embodiment, the first lance (1) may be supplied with the first fluid, the second lance (2) may be supplied with the second fluid, and the tube member (4) may be supplied with a third fluid. Here, it may be noted that the first fluid, the second fluid, and the third fluid may be elected in such a way that the second fluid and the third fluid form the combustible mixture, while the first fluid may act as the oxidizing agent. However, one skilled in the art should not construe the sequence of supplying fluid to the first lance (1), the second lance (2), and the tube member (3) to be a limitation, as the sequence may be varied per application of the injector (50).

It is to be noted that, the application of the injector (50) may not be limited to the scramjet engine (100), as one skilled in the art would readily recognize that the injector (50) may be employed for applications including, but not limited to, spray coating, food processing industries, cooling, quenching, drying, and the like.

It should be construed that the various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Equivalents

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals

| Particulars | Numerical |
|---|---|
| First lance | 1 |
| Second lance | 2 |
| First inlet port | 3a |
| Second inlet port | 3b |
| Tube member | 4 |
| First end of the tube member | 5a |
| Second end of the tube member | 5b |
| Recess | 6 |
| First exit port | 7a |
| Second exit port | 7b |
| Securing means | 8 |
| Air-inlet chamber | 20 |
| Combustion chamber | 21 |
| Injector | 50 |
| Scramjet engine | 100 |
| First fluid supplying means | 150 |
| Second fluid supplying means | 200 |
| Transverse plane of the first lance | A-A |
| Axial axis of the first lance | B-B |
| Axial axis of the first inlet port | C-C |

We claim:

1. An injector (50) for dispensing an effervescent fluid, comprising:
a first lance (1) provisioned with at least one first inlet port (3a), to receive a first fluid;
a second lance (2) coaxially disposed within the first lance (1), the second lance (2) is provisioned with at least one second inlet port (3b), to receive a second fluid; and
a tube member (4) disposable within the second lance (2) to receive the first fluid at one end and sealed at another end, wherein the tube member (4) is provisioned with at least one recess (6) for the first fluid in the tube member (4) to mix with the second fluid of the second lance (2) and form the effervescent fluid, and
dispense the effervescent fluid through at least one of a first exit port (7a) of the first lance (1) and a second exit port (7b) of the second lance (2).

2. The injector (50) as claimed in claim 1, wherein the at least one first inlet port (3a) is positioned about a transverse plane (A-A) of the first lance (1), and is configured to perpendicularly extend along the transverse plane (A-A).

3. The injector (50) as claimed in claim 1, wherein the at least one second inlet port (3b) is configured to perpendicularly extend from the second lance (2), about an axial axis (B-B) of the second lance (2).

4. The injector (50) as claimed in claim 1, wherein the at least one first inlet port (3a) of the first lance (1) and the tube member (4) are connectable with a first fluid supplying apparatus (150), to receive the first fluid.

5. The injector (50) as claimed in claim 1, wherein the first fluid conveyed through the first lance (1) is configured to propel the effervescent fluid, via the first exit port (7a).

6. The injector (50) as claimed in claim 2, wherein the at least one first inlet port (3a) includes a first port (3a′) and a second port (3a″), positioned on an axial axis (C-C).

7. The injector (50) as claimed in claim 2, wherein the first port (3a′) is positioned along the axial axis (C-C) and the second port (3a″) is positioned on an axial axis (C′-C′) .

8. The injector (50) as claimed in claim 1, wherein the tube member (4) is coupled to the second lance (2) at a first end (5a), which is projected outwardly from the second lance (2), and the second end (5b) is adapted to be positioned proximal to the second exit port (7b).

9. A fluid injector system (100), comprising:
a first fluid supplying apparatus (150) configured to supply a first fluid;
a second fluid supplying apparatus (200) configured to supply a second fluid; and
an injector (50) coupled to the first fluid supplying apparatus (150) and the second fluid supplying apparatus (200), for dispensing an effervescent fluid, comprising:
a first lance (1) provisioned with at least one first inlet port (3a), to receive a first fluid;
a second lance (2) coaxially disposed within the first lance (1), the second lance (3b) is provisioned with at least one second inlet port (3b), to receive a second fluid; and
a tube member (4) disposable within the second lance (2) to receive the first fluid at one end and sealed at another end, wherein the tube member (4) is provisioned with at least one recess (6) for the first fluid in the tube member (4) to mix with the second fluid of the second lance (2) and form the effervescent fluid, and
dispense the effervescent fluid through at least one of a first exit port (7a) of the first lance (1) and a second exit port (7b) of the second lance (2).

10. The system (100) as claimed in claim 9, wherein the at least one first inlet port (3a) is positioned about a transverse plane (A-A) of the first lance (1) and is configured to perpendicularly extend along the transverse plane (A-A), to connect with the first fluid supplying apparatus (150).

11. The system (100) as claimed in claim 9, wherein the at least one second inlet port (3b) is configured to perpendicularly extend from the second lance (2), about an axial axis (B-B) of the second lance (2), to connect with the second fluid supplying apparatus (200).
